(19) United States
(12) Patent Application Publication
(10) Pub. No.: US 2012/0022731 A1
(43) Pub. Date: Jan. 26, 2012

(54) Series-Drive Operation During Launch and Creep of a Hybrid Electric Vehicle

(75) Inventors: Ming L. Kuang, Canton, MI (US); Fazal U. Syed, Canton, MI (US); Per J. Jurland, Stora Hoga (SE); Mark S. Yamazaki, Canton, MI (US); Ihab S. Soliman, Canton, MI (US); Mathew A. Boesch, Plymouth, MI (US); Deepak Aswani, Westland, MI (US)

(73) Assignee: FORD GLOBAL TECHNOLOGIES, LLC, Dearborn, MI (US)

(21) Appl. No.: 12/839,592

(22) Filed: Jul. 20, 2010

(51) Int. Cl. G06F 19/00; B60W 20/00

(52) U.S. Cl. 701/22; 180/65.21

(57) ABSTRACT

A method for launching a vehicle includes determining that vehicle speed is less than a reference, demanded wheel power is less than a reference wheel power, and demanded engine power is less than a reference engine power; charging a battery using a generator driven by an engine; using an electric machine powered by the battery to drive vehicle wheels; and opening a clutch located in a drive path between a transmission and the generator.

### BACKGROUND OF THE INVENTION

1. Field of the Invention

This invention relates generally to control of a vehicle powertrain, and more particularly, to operating the powertrain in series-drive mode during a vehicle launch condition.

2. Description of the Prior Art

The powertrain for hybrid electric vehicle may include two electric machines in combination with an engine and transmission to operate in at least two operating modes, series and parallel drive, sometimes called a dual-drive hybrid-electric powertrain configuration. The first electric machine is mechanically coupled between the engine and transmission on the front axle in order to provide starter/generator capability. The second electric machine,) is connected to the rear axle in order to provide additional propulsion capability in either an electric or hybrid drive mode, resulting in two independently driven axles. The electric machines are powered by a high-voltage battery using inverters.

This powertrain configuration provides great flexibility for operating the powertrain in various modes, such as electric mode, series mode, and parallel or split mode to satisfy the driver's demand and achieve better fuel efficiency without compromising other vehicle performance attributes.

Given the architectural complexity and the operational flexibility of this powertrain, it is essential to have a highly coordinated vehicle control system to perform the blending of torque, speed, and power from multiple power sources in addition to managing transmission, engine and electric machine subsystem control.

In general, the operating losses associated operation of an input clutch of a manual transmission or a powershift transmission are significant. When launching a vehicle from a stop or a near stop speed (sometimes called “drive-away”) with the accelerator pedal fully, or nearly fully depressed, vehicle fuel economy is adversely affected due to excessive slip across the clutch.

A need exists in the industry for a powertrain operating mode in which vehicle fuel economy is maximized when launching a stopped vehicle or when vehicle speed and wheel power demands are low.

### SUMMARY OF THE INVENTION

A method for launching a vehicle includes determining that vehicle speed is less than a reference, demanded wheel power is less than a reference wheel power, and demanded engine power is less than a reference engine power; charging a battery using a generator driven by an engine; using an electric machine powered by the battery to drive vehicle wheels; and opening a clutch located in a drive path between a transmission and the generator.

A powertrain for launching a vehicle includes an engine, a generator driveably connected to the engine, a transmission driveably connected to a first set of wheels, a clutch for connecting and disconnecting the transmission and the engine, a battery electrically connected to the generator, an electric machine driveably connected to a second set of wheels and electrically connected to the battery, and a controller configured to determine presence of a vehicle launch condition, and to operate the powertrain in a series-drive mode.

The method causes the powertrain to operate in series-drive mode during vehicle launch and creep conditions, thereby improving fuel economy by operating the engine in more efficient region and lengthening the service life of the clutch by eliminating operating losses due to clutch slip.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a schematic diagram of a vehicle CISG ERAD powertrain and its controller;

FIG. 2 shows the power flow in an electric-drive mode of the powertrain of FIG. 1;

FIG. 3 shows the power flow in a series-drive mode of the powertrain of FIG. 1;

FIG. 4 shows the power flow in a parallel-drive mode of the powertrain of FIG. 1; and

FIG. 5 is a schematic diagram of the gearing, shafts and couplers of a powershift transmission.

### DESCRIPTION OF THE PREFERRED EMBODIMENT

FIG. 1 illustrates a dual-drive hybrid-electric powertrain 10, which includes two electric machines, a crankshaft integrated starter generator (CISG) 12 and an electric rear drive (ERAD) 14; an engine 16; and a transmission 20 having at least one wet input clutch 22, which transmits power to the transmission input 24.

The CISG 12 is located in a drive path and mechanically coupled between the crankshaft of engine 16 and the transmission input clutch 22 on the front axle 26 in order to provide starter/generator capability to the engine. Front axle transmits power to front wheels 28, 29. When operating as a generator, CISG 12 produces electric power which is stored in a high-voltage (HV) battery 34.

The ERAD 14, a motor connected to the rear axle 30, can provide additional propulsion capability to the rear wheels 32, 33 in either an electric or hybrid drive mode, resulting in two independently driven axles 26, 30. ERAD 14 is powered by battery 34 using inverters.

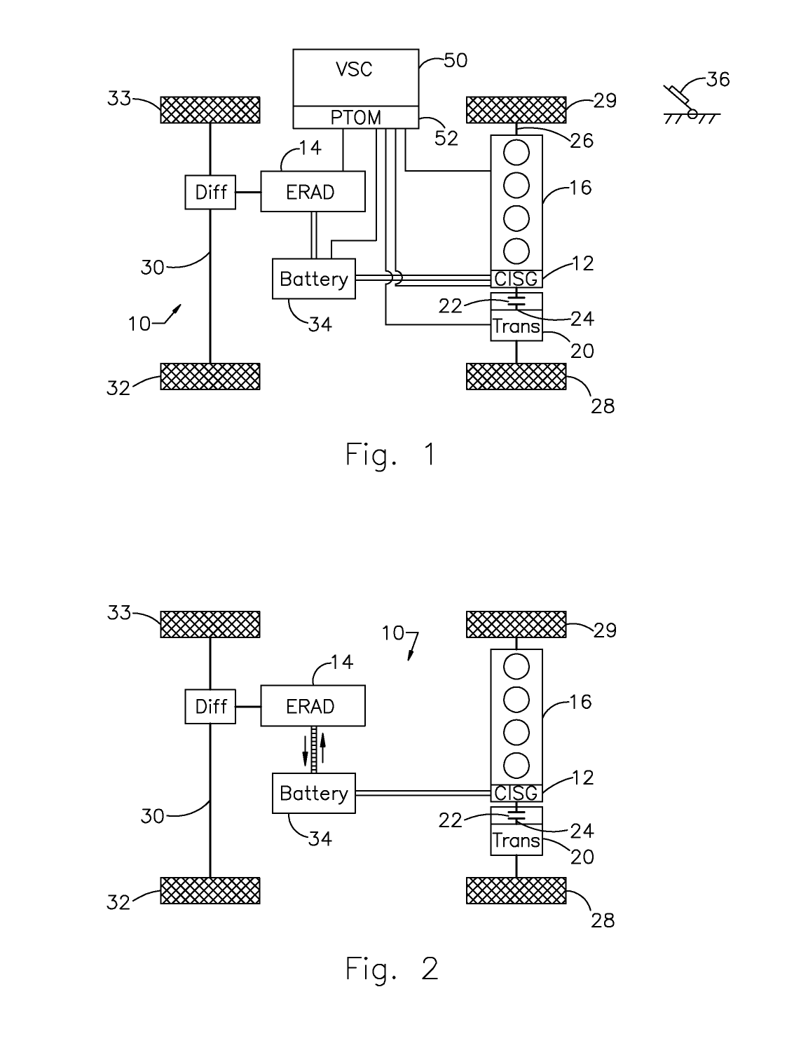

The CISG-ERAD driveline configuration shown in FIG. 1 enables the vehicle to operate in one of three main operational modes. The first mode of operation, shown in FIG. 2 is the electric-drive, wherein the battery 34 supplies electric power to the ERAD 14 in order to propel the vehicle.

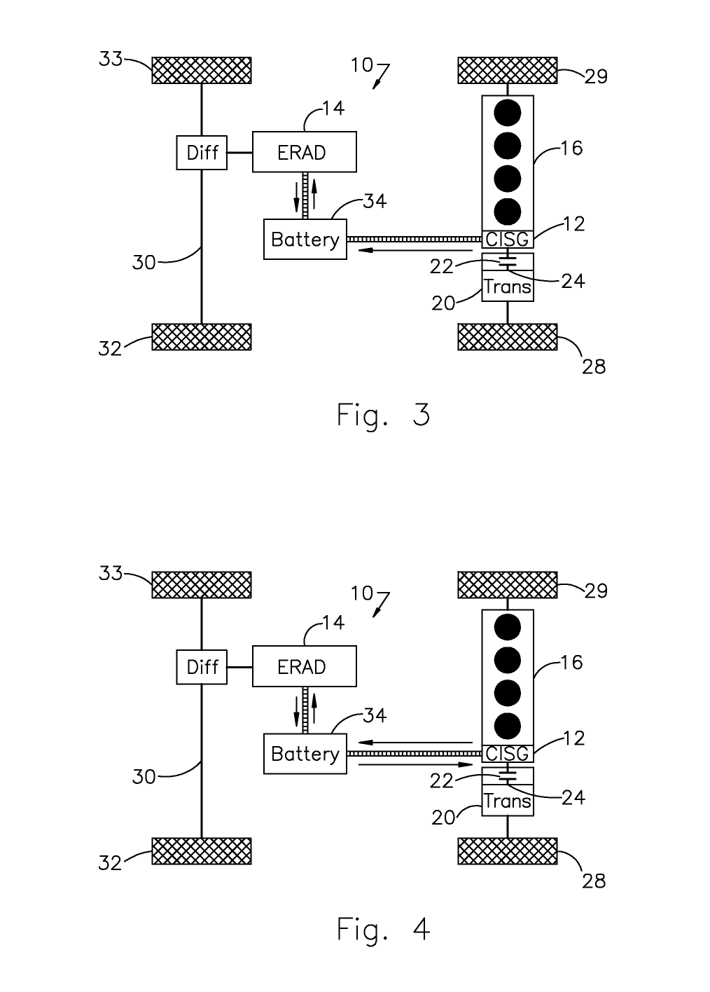

The second mode of operation, shown in FIG. 3, is series-drive, wherein the engine 16 drives CISG 12 to charge the battery 34, which supplies power to the ERAD 14 to propel the vehicle. In series-drive operation, the engine output power is not directly transmit to the wheels 28, 29, 32, 33 because clutch 22 is open or disengaged. Instead, engine 16 drives CISG 12 to generate electricity that can be used by the ERAD 14 to propel the vehicle according to the driver demand. Since the engine speed is decouple from the vehicle speed, the engine operating point (torque and speed selection for a given engine power request) is placed in the most efficient operating region, as much as possible.

The third mode of operation, shown in FIG. 4, is parallel-drive or split-drive, wherein the engine 16 and transmission 20 provide torque to the front wheels 28, 29 while the battery 34 and ERAD 14 provide torque to the rear wheels 32, 33 in order to propel the vehicle.

In order to coordinate actions of the vehicle subsystems, a Vehicle System Controller (VSC) 50, includes a function called Powertrain Operating Mode (PTOM) control 52, which coordinates the operation of the engine 16, transmission 20, CISG 12, ERAD 14 and battery 34 subsystems in order to produce alternately electric-drive, series-drive, parallel-drive, engine start, and engine stop. A control algorithm in PTOM control 52 determines whether to request speed control or power control from the subsystems, based upon various vehicle and vehicle driver inputs including a vehicle launch condition.

During a drive condition wherein vehicle speed is lower than a reference speed, or demanded engine power is less than a reference engine power, or demanded wheel power is less than a reference wheel power, as evidenced by the extent to which an accelerator pedal 36 is depressed, powertrain 10 is operated in series-drive mode illustrated in FIG. 2. In series-drive mode, clutch 22 is disengaged. Therefore power produced by the engine 16 is not directly transmitted to the wheels. Instead, engine 16 drives CISG 12 to generate electric power, which is transmitted to battery 34, from which electric power is transmitted to ERAD 14 in accord with driver demand. Wheels 32, 33 are driven by ERAD 14.

Since engine speed is decoupled from vehicle speed, the engine operating point, i.e., engine torque and engine speed for a given engine demanded power, is placed in the most efficient operating region.

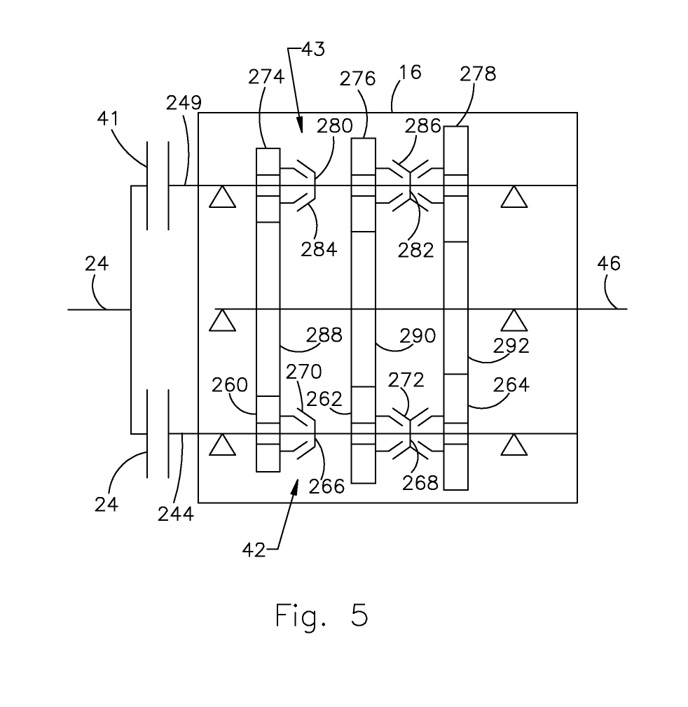

FIG. 5 illustrates details of a powershift transmission 20 including a first input clutch 24, which selective connects the input 24 of transmission 20 alternately to the even-numbered gears 42 associated with a first layshaft 244, and a second input clutch 41, which selective connects the input 20 alternately to the odd-numbered gears 43 associated with a second layshaft 249.

Layshaft 244 supports pinions 260, 262, 264, which are each journalled on shaft 244, and couplers 266, 268, which are secured to shaft 244. Pinions 260, 262, 264 are associated respectively with the second, fourth and sixth gears. Coupler 266 includes a sleeve 270, which can be moved leftward to engage pinion 260 and driveably connect pinion 260 to shaft 244. Coupler 268 includes a sleeve 272, which can be moved leftward to engage pinion 262 and driveably connect pinion 262 to shaft 244 and can be moved rightward to engage pinion 264 and driveably connect pinion 264 to shaft 244.

Layshaft 249 supports pinions 274, 276, 278, which are each journalled on shaft 249, and couplers 280, 282, which are secured to shaft 249. Pinions 274, 276, 278 are associated respectively with the first, third and fifth gears. Coupler 280 includes a sleeve 284, which can be moved leftward to engage pinion 274 and driveably connect pinion 274 to shaft 249. Coupler 282 includes a sleeve 286, which can be moved leftward to engage pinion 276 and driveably connect pinion 276 to shaft 249 and can be moved rightward to engage pinion 278 and driveably connect pinion 278 to shaft 249.

Transmission output 46 supports gears 288, 290, 292, which are each secured to shaft 46. Gear 288 meshes with pinions 260 and 274. Gear 290 meshes with pinions 262 and 276. Gear 292 meshes with pinions 264 and 278.

Couplers 266, 268, 280 and 282 may be synchronizers, or dog clutches or a combination of these. Although operation of the transmission 20 is described with reference to forward drive only, the transmission can produce reverse drive by incorporating a reverse idler gear in one of the lower power paths and a reverse coupler for engaging reverse drive. One of the input clutches 24, 41 would be engaged when reverse drive operation is selected.

In accordance with the provisions of the patent statutes, the preferred embodiment has been described. However, it should be noted that the alternate embodiments can be practiced otherwise than as specifically illustrated and described.

The invention claimed is:

1. A method for launching a vehicle, comprising:
determining that vehicle speed is less than a reference, demanded wheel power is less than a reference wheel power, and demanded engine power is less than a reference engine power;
charging a battery using a generator driven by an engine;
using an electric machine powered by the battery to drive vehicle wheels;
opening a clutch located in a drive path between a transmission and the generator.

2. The method of claim 1, wherein the transmission is a multiple speed powershift transmission driveably connected to the engine through the generator and the clutch.

3. The method of claim 1, wherein the transmission is a multiple speed manual transmission driveably connected to the engine through the generator and the clutch.

4. The method of claim 1, wherein the transmission is a multiple speed automatic transmission driveably connected to the engine through a torque converter.

5. A powertrain for launching a vehicle, comprising:
an engine;
a generator driveably connected to the engine;
a transmission driveably connected to a first set of wheels;
a clutch for connecting and disconnecting the transmission and the engine;
a battery electrically connected to the generator;
an electric machine driveably connected to a second set of wheels and electrically connected to the battery; and
a controller configured to determine presence of a vehicle launch condition, and to operate the powertrain in a series-drive mode.

6. The powertrain of claim 5, wherein the controller is further disposed to determine presence of a vehicle launch condition when vehicle speed is less than a reference speed, demanded wheel power is less than a reference wheel power, and demanded engine power is less than a reference engine power.

7. The powertrain of claim 5, wherein the controller is further disposed to charge the battery using a generator driven by the engine, use the electric machine powered by the battery to drive the second set of wheels, and to open a clutch located in a drive path between the transmission and the generator.
